(19) United States
(12) Patent Application Publication
(10) Pub. No.: US 2024/0212517 A1
(43) Pub. Date: Jun. 27, 2024

(54) TEACHER DATA EDITING ASSISTANCE SYSTEM, TEACHER DATA EDITING ASSISTANCE METHOD, AND TEACHER DATA EDITING ASSISTANCE PROGRAM

(71) Applicant: Hitachi Solutions, Ltd., Tokyo (JP)

(72) Inventors: Yuxin LIANG, Tokyo (JP); Masashi EGI, Tokyo (JP); Koji NAKAYAMA, Tokyo (JP)

(21) Appl. No.: 18/239,955

(22) Filed: Aug. 30, 2023

(30) Foreign Application Priority Data
Dec. 27, 2022 (JP) 2022-209963

(51) Int. Cl. G09B 7/08

(52) U.S. Cl. CPC G09B 7/08

(57) ABSTRACT

A teacher data editing support system includes a determination unit that receives teacher data including sensitive attribution as a variable that potentially causes discrimination, a feature as a variable to be used for prediction, and a correct answer, and calculates contribution as an index indicating contribution of the sensitive attribution to the correct answer, a display unit that visually presents evaluation information indicating a relationship between a level of changing the correct answer in the teacher data and a level of deviation of the correct answer from an initial value or a discrimination level based on the contribution, and an editing unit that accepts designation of how much the correct answer is changed, changes the correct answer in the teacher data in response to the designation, and outputs the changed teacher data.

### CROSS-REFERENCE TO RELATED APPLICATION

The present application claims priority from Japanese application JP2022-209963, filed on Dec. 27, 2022, the content of which is hereby incorporated by reference into this application.

### BACKGROUND OF THE INVENTION

### 1. Field of the Invention

The present disclosure relates to a teacher data editing support system for machine learning, a teacher data editing support method, and a teacher data editing support program.

### 2. Description of the Related Art

In machine learning, there are cases where histories of various human activities carried out in the past are used as teacher data. In the past, human beings may have been treated discriminately due to differences in various attributes of human beings. Therefore, information including such discriminate treatment may exist in the past activity histories. For example, a past credit history at a financial institution may include traces of discrimination based on race, gender, or the like. An artificial intelligence (AI) model generated by performing machine learning using data including such discrimination as teacher data may make a sensitive determination. Therefore, it is desirable to reduce sensitive determination to be made by an AI model and improve fairness.

WO 2022/123907 A1 discloses a technique of improving fairness. The technique is based on the assumption that an increase in the number of pieces of teacher data improves prediction accuracy of a model and thus improves fairness. With this technique, a perturbation image of an image having attribute information in a relatively small number of pieces of the teacher data is generated to be added to the teacher data in the field of images.

Kamiran, Faisal, and Toon Calders. “Data preprocessing techniques for classification without discrimination.” Knowledge and information systems 33.1 (2012): 1-33 discloses a method for a case where a variable such as an attribute that may cause discrimination is sensitive attribution and both the sensitive attribution and a correct answer are binary. With this method, a ratio of a state where the correct answer is desirable for each sensitive attribution is calculated as an index of fairness, and the correct answer is rewritten for improving the index.

### SUMMARY OF THE INVENTION

In the technique disclosed in WO 2022/123907 A1, it is assumed that the prediction accuracy of the model heightened and the fairness is improved as the number of pieces of teacher data increases, but this is not always the case. For example, if an original image from which a perturbation image is generated is affected by the sensitive attribution, addition of the perturbation image for increasing the teacher data may not reduce the influence of the sensitive attribution in the model. The method disclosed in Kamiran, Faisal, and Toon Calders. “Data preprocessing techniques for classification without discrimination.” Knowledge and information systems 33.1 (2012): 1-33 can be applied to a binary classification problem in which correct answer is represented by a binary value, but cannot be applied to other problems such as a regression problem.

One object of the present disclosure is to provide a technique for supporting a decrease of sensitive determination made by a machine learning model.

One aspect of the present disclosure provides a teacher data editing support system including a determination unit that receives teacher data including sensitive attribution as a variable that potentially causes discrimination, a feature as a variable to be used for prediction, and a correct answer, and calculates contribution as an index indicating contribution of the sensitive attribution to the correct answer, a display unit that visually presents evaluation information indicating a relationship between a level of changing the correct answer in the teacher data and a level of deviation of the correct answer from an initial value or a level of discrimination based on the contribution, and an editing unit that accepts designation of how much the correct answer is change, changes the correct answer in the teacher data in response to the designation, and outputs the changed teacher data.

One aspect of the present disclosure provides a teacher data editing support method performed by an apparatus having a processing device, including receiving teacher data including sensitive attribution as a variable that potentially causes discrimination, a feature as a variable to be used for prediction, and a correct answer and calculating contribution as an index indicating contribution of the sensitive attribution to the correct answer, visually presenting evaluation information indicating a relationship between a level of changing the correct answer in the teacher data and a level of deviation of the correct answer from an initial value or a discrimination level based on the contribution, and accepting designation of how much the correct answer is changed, changing the correct answer in the teacher data in response to the designation, and outputting the changed teacher data.

One aspect of the present disclosure provides a teacher data editing support program for causing an apparatus having a processing device to perform receiving teacher data including sensitive attribution as a variable that potentially causes discrimination, a feature as a variable to be used for prediction, and the correct answer and calculating contribution as an index indicating contribution of the sensitive attribution to the correct answer, visually presenting evaluation information indicating a relationship between a level of changing the correct answer in the teacher data and a level of deviation of the correct answer from an initial value or a discrimination level based on the contribution, and accepting designation of how much the correct answer is changed, changing the correct answer in the teacher data in response to the designation, and outputting the changed teacher data.

According to one aspect of the present disclosure, it is possible to reduce sensitive determination by a machine learning model.

### BRIEF DESCRIPTION OF THE DRAWINGS

FIG. 1 is a functional block diagram illustrating a configuration example of a teacher data editing support system;

FIG. 2 is a conceptual diagram illustrating a format of teacher data;

FIG. 3 is a conceptual diagram illustrating a format of a determination result;

FIG. 4 is a conceptual diagram illustrating a format of edited teacher data;

FIG. 5 is a flowchart illustrating information processing performed by a determination unit;

FIG. 6 is a flowchart illustrating information processing performed by an editing unit;

FIG. 7 is a conceptual diagram illustrating a format of determination history data;

FIG. 8 is a conceptual diagram illustrating a first display example by a display unit;

FIG. 9 is a conceptual diagram illustrating a second display example by the display unit;

FIG. 10 is a conceptual diagram illustrating a third display example of the display unit;

FIG. 11 is a conceptual diagram illustrating a format of teacher data;

FIG. 12 is a conceptual diagram illustrating a format of a determination result;

FIG. 13 is a conceptual diagram illustrating a format of edited teacher data;

FIG. 14 is a functional block diagram illustrating a configuration example of the teacher data editing support system;

FIG. 15 is a conceptual diagram illustrating a format of requirement information;

FIG. 16 is a flowchart illustrating information processing performed by a suggestion generating unit;

FIG. 17 is a functional block diagram illustrating a configuration example of the teacher data editing support system;

FIG. 18 is a flowchart illustrating information processing performed by an association tabulating unit;

FIG. 19 is a conceptual diagram illustrating a format of a combination mask;

FIG. 20 is a conceptual diagram illustrating a format of an association tabulation result;

FIG. 21 is a flowchart illustrating information processing performed by a contribution calculating unit;

FIG. 22 is a conceptual diagram illustrating a format of an association tabulation result;

FIG. 23 is a conceptual diagram illustrating a format of a provisional contribution result;

FIG. 24 is a block diagram illustrating a configuration example of the teacher data editing support system; and

FIG. 25 is a conceptual diagram illustrating a hardware configuration example of a calculator.

### DESCRIPTION OF THE PREFERRED EMBODIMENTS

Hereinafter, embodiments of the present invention will be described with reference to the drawings.

### First Embodiment

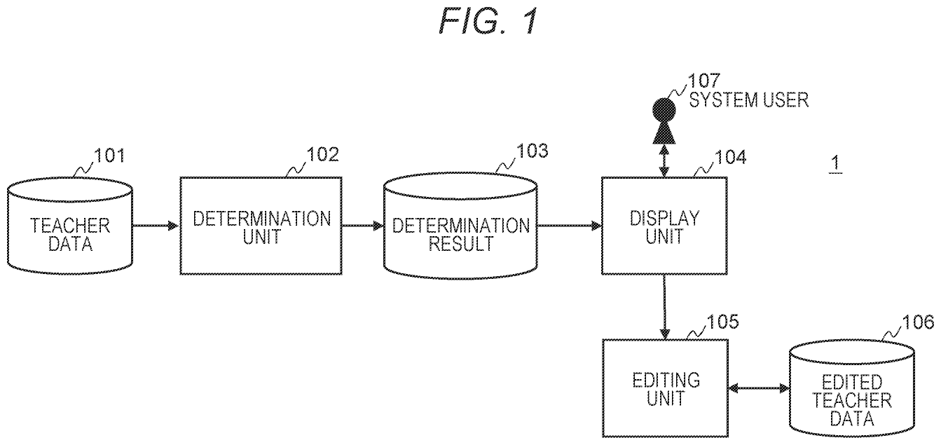

FIG. 1 is a functional block diagram illustrating a configuration example of a teacher data editing support system.

A teacher data editing support system 1 includes at least a processing device and a storage device that are not illustrated. The teacher data editing support system 1 may further include a communication device, an input device, an output device, and the like.

The processing device includes, for example, a central processing unit (CPU), a micro processing unit (MPU), a graphics processing unit (GPU), a field-programmable gate array (FPGA), or the like. Various functions of the teacher data editing support system 1 are implemented by the processing device reading various programs and data stored in the storage device and executing the programs.

More specifically, the processing device reads various programs and data stored in the storage device and executes the programs, thereby implementing a determination unit 102, a display unit 104, and an editing unit 105.

The storage device is a device that stores programs and data, and is, for example, a random access memory (RAM), a read only memory (ROM), or a non-volatile semiconductor memory (NVRAM).

The storage device may be, for example, a storage area of a cloud server or a device that performs reading and writing on a recording medium such as a hard disc drive (HDD), a solid state drive (SSD), a storage system, an integrated circuit (IC) card, a secure digital (SD) memory card, or an optical recording medium (Compact Disc (CD), Digital Versatile Disc (DVD), etc.).

The storage device may be a combination of a plurality of the above-described various storage devices.

Various programs and data are stored in the storage device. Specifically, teacher data 101, a determination result 103, and an edited teacher data 106 are stored in the storage device. Note that these pieces of data may be divisionally stored in the plurality of storage devices, or may be stored in one storage device.

The communication device is a wired or wireless communication interface that implements communication with another device via communication means such as a local area network (LAN) or the Internet, and is, for example, a network interface card (NIC), a wireless communication module, a universal serial interface (USB) module, or a serial communication module.

The input device is a device that receives an input from a user. The input device is, for example, a keyboard, a mouse, a touch panel, a card reader, or a voice input device.

The output device is a device that provides a user with various types of information such as processing progress and a processing result. The output device is, for example, a screen display device (liquid crystal display (LCD), head mounted display (HMD), or the like), an audio output device, a printing device, or the like. Note that the teacher data editing support system 1 may be configured to receive and output information from and to another device via the communication device.

The determination unit 102 receives teacher data including sensitive attribution that is a variable that potentially causes discrimination, a feature that is a variable used for prediction, and a correct answer, and calculates contribution that is an index indicating contribution of the sensitive attribution to the correct answer.

The display unit 104 visually presents evaluation information indicating a relationship between a level of changing the correct answer in the teacher data, a level of deviation of the correct answer from an initial value, and a discrimination level based on the contribution. A system user 107 checks the presented contents.

The editing unit 105 accepts designation of how much the correct answer is changed, changes the correct answer in the teacher data in response to the designation, and outputs the changed teacher data as the edited teacher data 106.

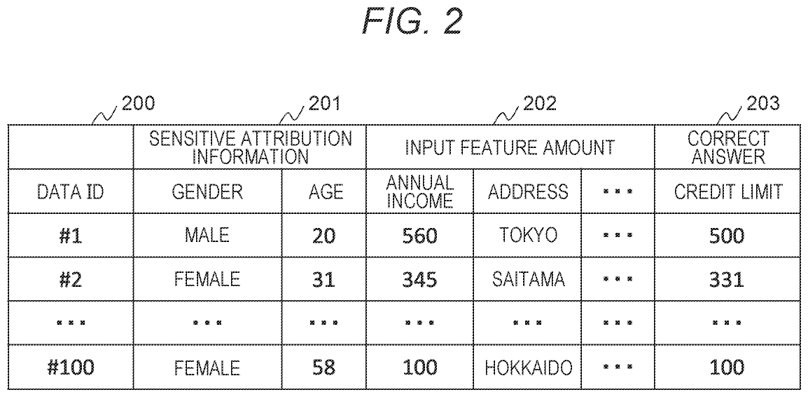

FIG. 2 is a conceptual diagram illustrating a format of the teacher data. The teacher data includes a data identification (ID) 200, sensitive attribution information 201, an input feature 202, and a correct answer 203. The sensitive attribution information 201 includes, for example, information such as gender and age as sensitive attribution as a variable that potentially causes discrimination. The input feature 202 is a variable used for prediction, and includes, for example, an annual income (in tens of thousands of yen), an address, and the like. The correct answer is a credit limit (in tens of thousands of yen) in the present embodiment, which is a one-dimensional value. Note that the first embodiment is an example of regression.

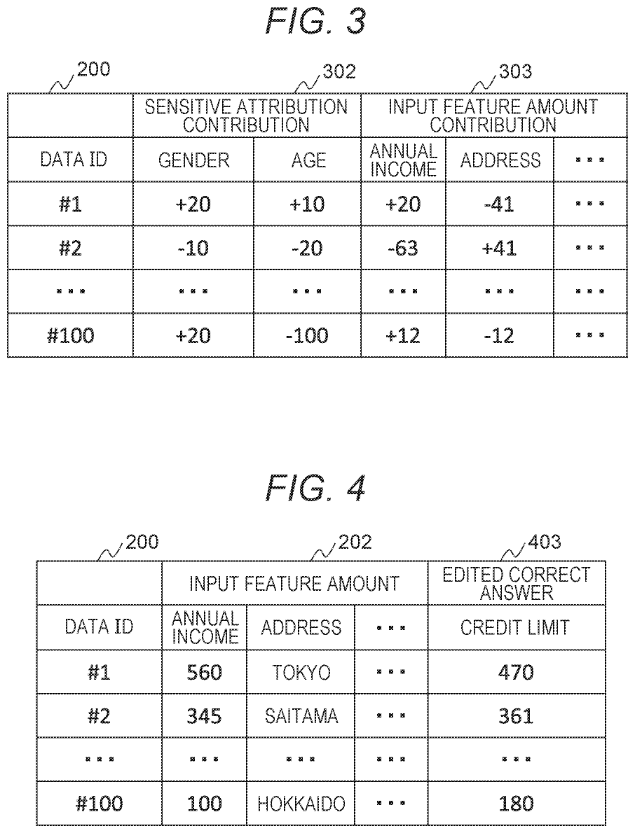

FIG. 3 is a conceptual diagram illustrating a format of the determination result. The determination result includes a data ID, sensitive attribution contribution 302 and input feature contribution 303. The above-described contribution corresponds to the sensitive attribution contribution 302 and the input feature contribution 303. The contribution is an index indicating contribution of the sensitive attribution to the correct answer.

FIG. 4 is a conceptual diagram illustrating a format of edited teacher data. The format of the edited teacher data is basically similar to the format of the teacher data, but the correct answer value is edited. The column of the edited correct answer is described as an edited correct answer 403.

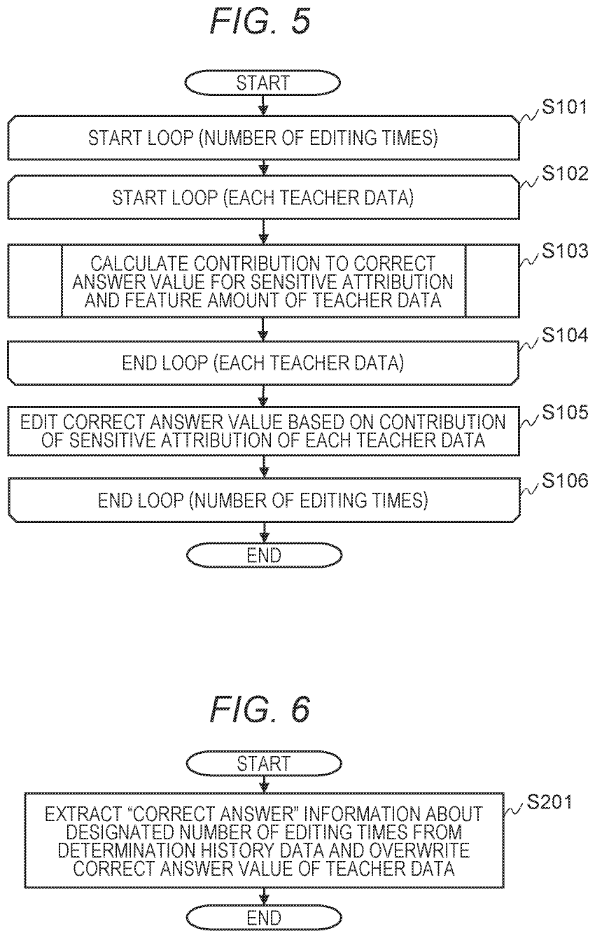

FIG. 5 is a flowchart illustrating information processing performed by the determination unit 102. The determination unit 102 performs processing in steps S102 to S105 every time the correct answer value is edited (loop in steps S101 and S106).

The determination unit 102 performs the processing in step S103 for each teacher data (loop in steps S102 and S104). In step S103, the determination unit 102 calculates the contribution to the correct answer value with respect to the sensitive attribution and the feature of the teacher data.

A calculation algorithm of the contribution includes, for example, a Shapley method. In the case of using the Shapley method, the determination unit 102 generates a prediction model from the teacher data and calculates a Shapley value for the prediction value. The contribution in this case is a Shapley value for the sensitive attribution in the correct answer. In addition, the calculation algorithm of the contribution may be a CohortShapley method for calculating the contribution directly from the teacher data. The calculation algorithm of the contribution is not limited thereto.

In step S105, the determination unit 102 edits the correct answer value depending on the contribution of the sensitive attribution of each teacher data.

Note that the determination unit 102 may repeatedly perform editing for subtracting the numerical value of the contribution from a numerical value indicating the correct answer and calculating the level of deviation of the correct answer from an initial value and the discrimination level based on the contribution.

FIG. 6 is a flowchart illustrating information processing performed by the editing unit. In step S201, the editing unit 105 extracts correct answer information about the designated editing frequency from the determination history data, and overwrites the correct answer value.

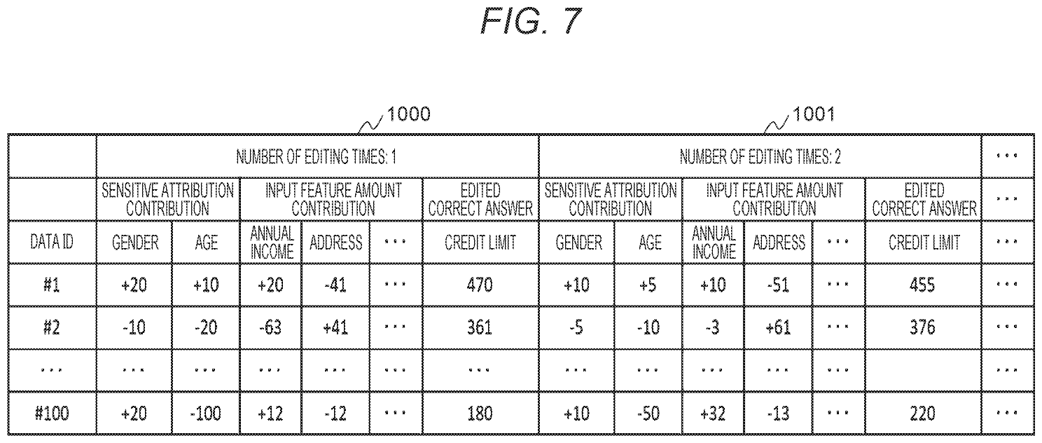

FIG. 7 is a conceptual diagram illustrating a format of the determination history data. The determination history data includes sensitive attribution contribution, input feature contribution, and an edited correct answer for each editing. The value of the edited correct answer is changed by editing, but the data before and after the change may be stored.

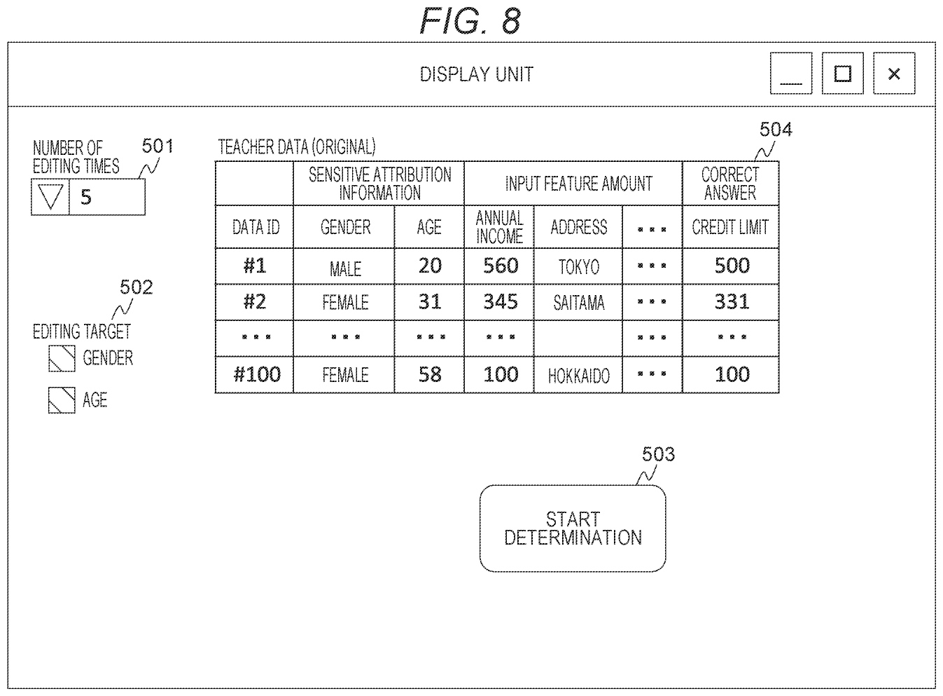

FIG. 8 is a conceptual diagram illustrating a first display example of the display unit. The display unit 104 displays a number-of-editing times 501, an editing target 502, a determination start button 503, and a data display area 504 for displaying data. The user selects the editing frequency. Further, the user inputs, for example, items such as gender and age as the editing target. In the data display area 504, a table based on original data of the teacher data is displayed. When the user presses the determination start button 503, the determination processing is started.

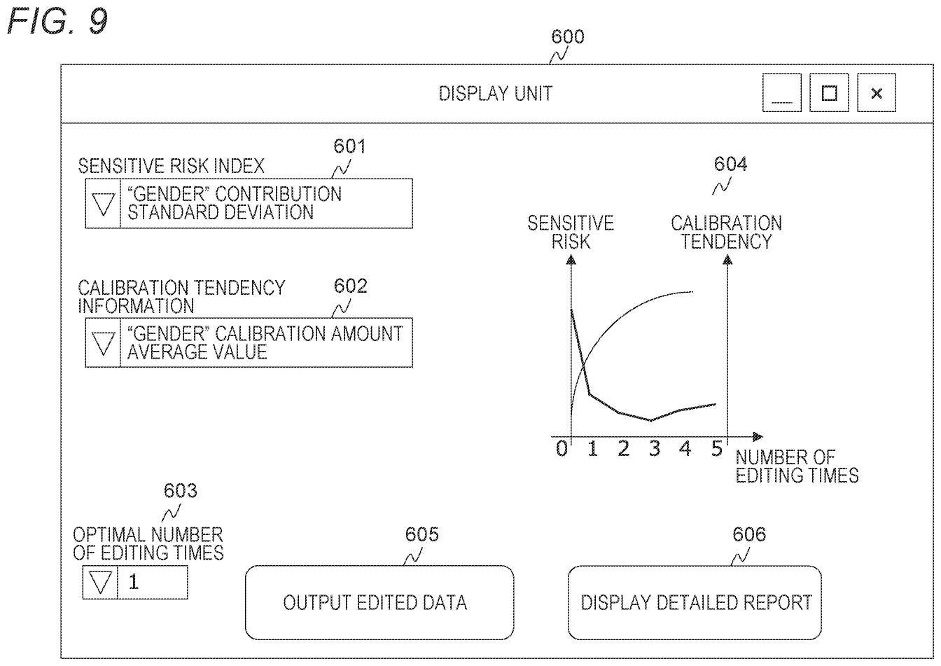

FIG. 9 is a conceptual diagram illustrating a second display example of the display unit. The display unit 104 of a second screen 600 displays a pull-down selection box 601 for a sensitive risk index, a pull-down selection box 602 for calibration tendency information, and a pull-down selection box 603 for an optimal editing frequency. In addition, the display unit 104 displays a graph 604 indicating the sensitive risk and the calibration tendency for each editing frequency, an edited data output button 605, and a detailed report display button 606.

The user operates the pull-down selection box 601 for the sensitive risk index to select the sensitive risk index desired to be displayed in the graph 604, such as “gender” and “age”. The user operates the pull-down selection box 602 for the calibration tendency information to select the calibration tendency information desired to be displayed in the graph 604, such as “gender” and “age”.

In the graph 604, the contents selected in the pull-down selection boxes are displayed with lines. The horizontal axis of the graph represents the editing frequency. The solid line indicates a value of the sensitive risk index, and the broken line indicates a value of the calibration tendency information. Note that as the editing frequency increases, the sensitive risk tends to decrease during the less editing frequency, and the decrease in the sensitive risk eventually decreases. As the editing frequency increases, the value of the calibration tendency information, that is, the level of deviation of the correct answer from the initial value tends to increase.

The display unit 104 displays the level of deviation of the correct answer from the initial value with respect to the editing frequency and the discrimination level based on the contribution. A broken curve in the graph 604 indicates the level of deviation of the correct answer from the initial value with respect to the editing frequency. A solid line in the graph 604 indicates the discrimination level based on the contribution with respect to the editing frequency.

When the user presses the edited data output button 605, the processing in the editing unit 105 is performed for the editing frequency selected in the pull-down selection box 603 for optimal editing frequency. When the user presses the detailed report display button 606, details of a determination result are displayed for the editing frequency edited in the pull-down selection box 603 for optimal editing frequency.

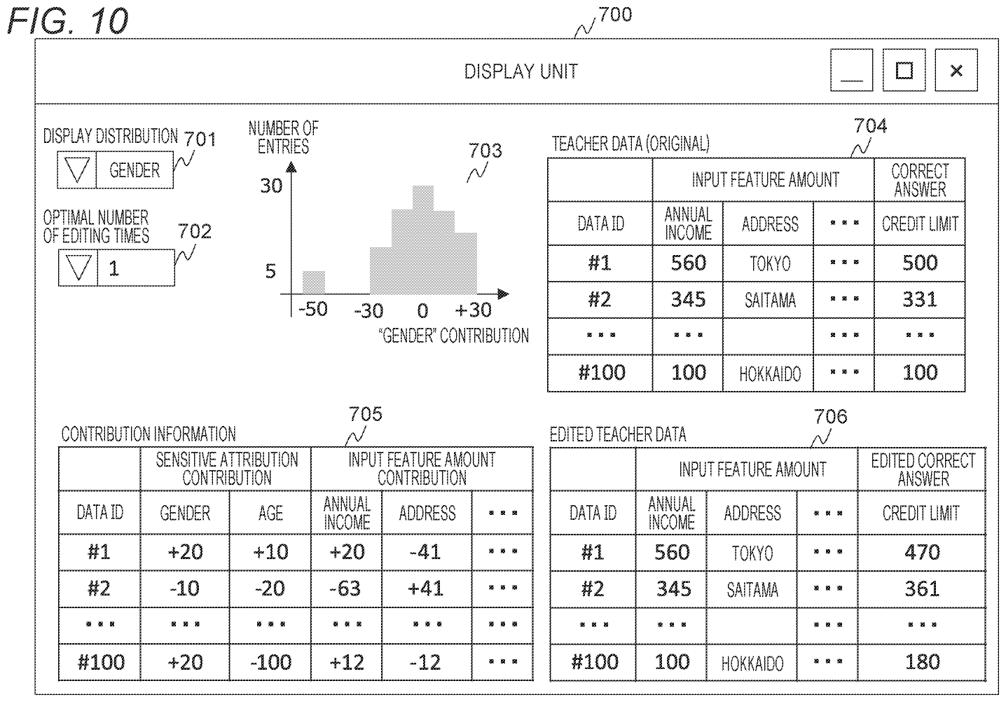

FIG. 10 is a conceptual diagram illustrating a third display example of the display unit. When the user presses the detailed report display button 606 on the second screen 600 illustrated in FIG. 6, a third screen 700 is displayed. The third screen 700 shows a pull-down selection box 701 for distribution display, a pull-down selection box 702 for optimum editing frequency, a graph 703 indicating distribution of a number the teacher data for each contribution, a table 704 of teacher data, a table 705 of contribution information, and a table 706 of edited teacher data.

The user operates the pull-down selection box 701 for distribution display to select a target desired to be displayed in the graph 703, such as “gender” or “age”. The horizontal axis of the graph 703 represents an item selected in the pull-down selection box 701 for distribution display, and in this example, the horizontal axis indicates the contribution of “gender”. The vertical axis of the graph 703 represents the number of the teacher data.

The table of the teacher data 704 shows teacher data before editing. For example, the credit limit of teacher data whose data ID is 1 is 500 which is the original value. The table of the edited teacher data 706 shows the edited teacher data corresponding to the editing frequency selected in the pull-down selection box 702 for optimum editing frequency. In this example, edited control data in a case where the editing frequency is one is displayed. By editing once, the credit limit of the teacher data whose data ID is 1 is 470. This is because, inspecting the row where the data ID is 1 in the contribution information, the contribution calculated with the Shapley method are +20 for gender and +10 for age, and thus+20 and +10 are subtracted from the original credit limit of 500. That is, 470 which is obtained in a manner that 500-20-10 is the credit limit on the row where data ID is 1 in the edited teacher data. Note that, focusing on each row where the data ID is 2, since an original credit limit of the teacher data is 331, the gender in the sensitive attribution contribution is −10, and the age is −20, the credit limit of the edited teacher data is 361 which is obtained in a manner that 331-(−10)-(−20).

### Second Embodiment

As a second embodiment, a case where the teacher data is teacher data for an identification problem will be described. The teacher data in this case is teacher data to be used for machine learning for an identification problem that classifies data into a plurality of categories. As for the initial value of a correct answer, a value of any one category is 1 and values of all the other categories are 0.

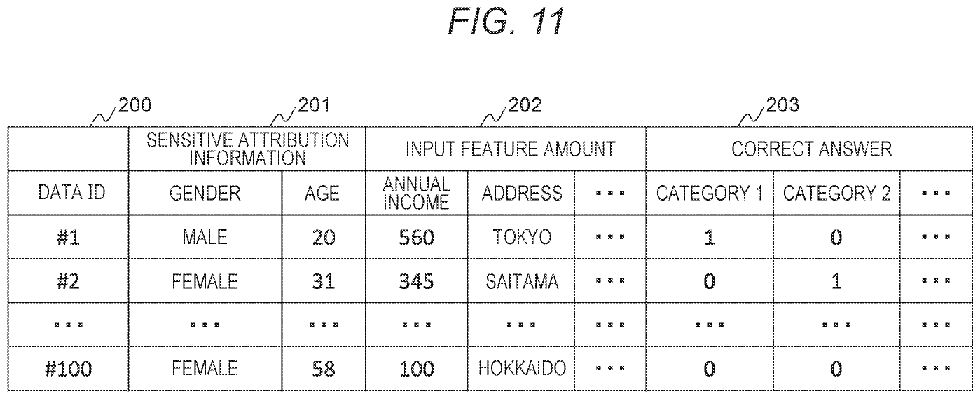

FIG. 11 is a conceptual diagram illustrating a format of the teacher data. The teacher data includes a data identification (ID) 200, sensitive attribution information 201, an input feature 202, and a correct answer 203. The sensitive attribution information 201 includes, for example, information such as gender and age as sensitive attribution as a variable that potentially causes discrimination. The input feature 202 is a variable used for prediction, and includes, for example, an annual income (in tens of thousands of yen), an address, and the like. The correct answer 203 is a one-hot vector based on one-hot encoding including a plurality of categories.

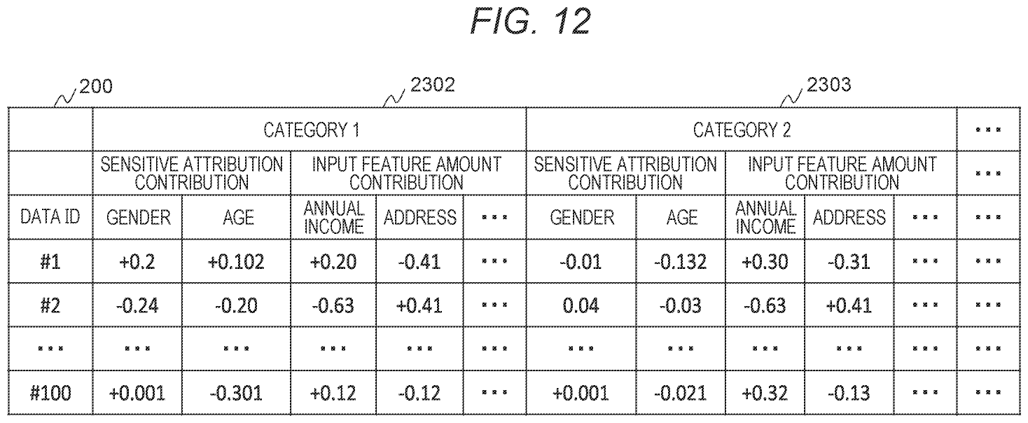

FIG. 12 is a conceptual diagram illustrating a format of a determination result. The determination result includes a data ID, sensitive attribution contribution and input feature contribution 303 for each category. The above-described contribution corresponds to the sensitive attribution contribution and the input feature contribution. The contribution is an index indicating contribution of the sensitive attribution to the correct answer. For example, in one editing, the determination unit 102 calculates the contribution of the sensitive attribution for each category, and subtracts the contribution of the sensitive attribution in a category of the correct answer from the value of the category of the correct answer.

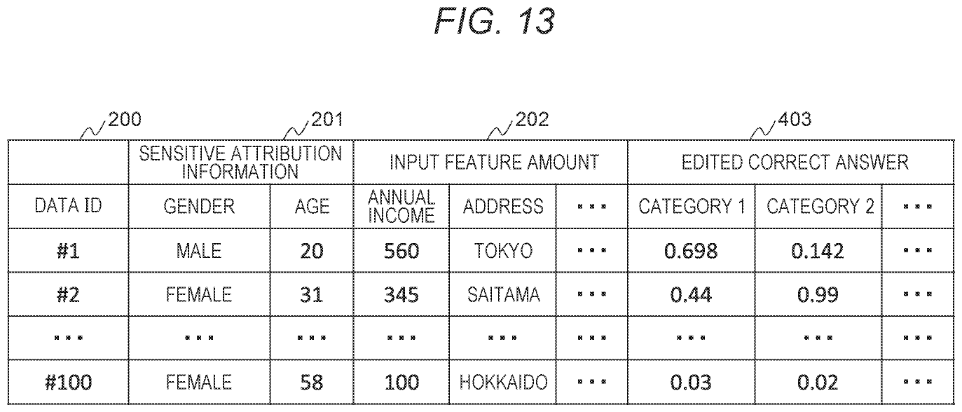

FIG. 13 is a conceptual diagram illustrating a format of edited teacher data. The format of the edited teacher data is basically similar to the format of the teacher data, but the correct answer value is edited. The column of the edited correct answer is illustrated as an edited correct answer 403. In addition, the edited correct answer 403 includes a correct answer value for each category.

### (Generation of Suggestion)

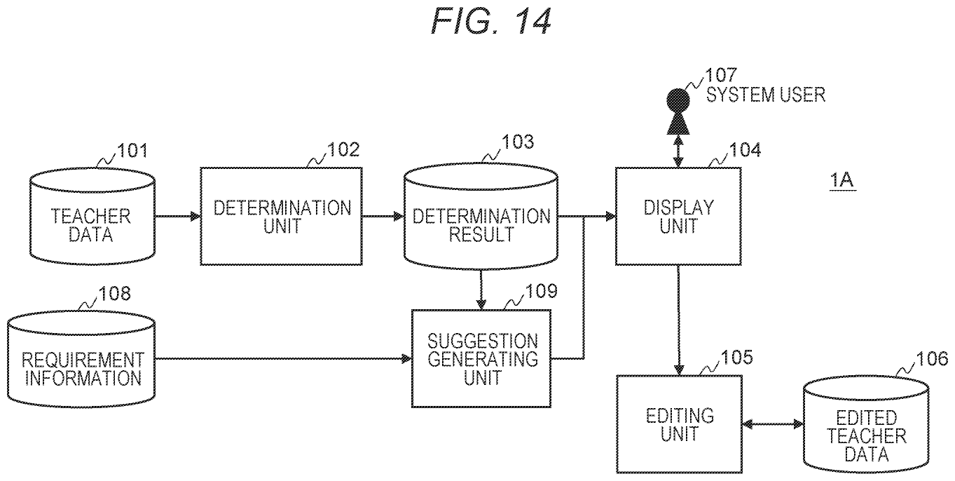

FIG. 14 is a functional block diagram illustrating a configuration example of a teacher data editing support system. Since the configuration of a teacher data editing support system 1A illustrated in FIG. 14 is substantially similar to the configuration of the teacher data editing support system 1 illustrated in FIG. 1, only the difference will be described.

The teacher data editing support system 1A includes a processing device. The processing device reads various programs and data stored in a storage device and executes the programs, thereby further implementing a suggestion generating unit 109. The storage device further stores requirement information 108.

The suggestion generating unit 109 accepts designation of the requirement information to be satisfied by the sensitive attribution contribution, and calculates how much the contribution satisfies the requirement information every time of the editing.

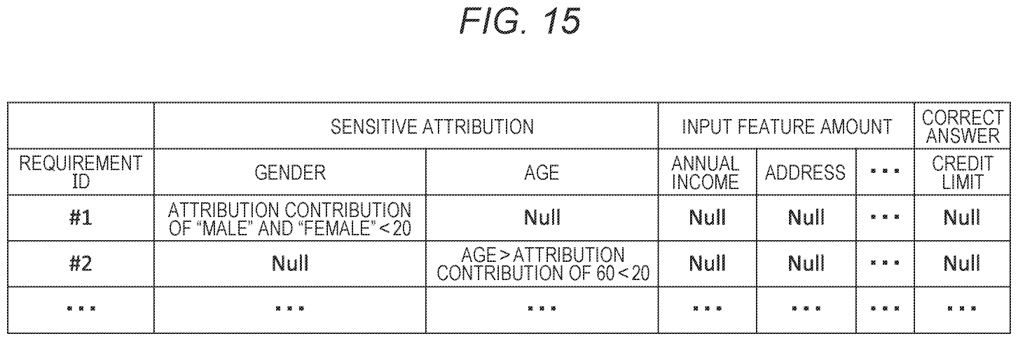

FIG. 15 is a conceptual diagram illustrating a format of the requirement information. The requirement information 108 includes a requirement ID, sensitive attribution, an input feature, and a correct answer. A condition under which the contribution satisfies the requirement information is defined for each piece of information about the sensitive attribution, the input feature, and the correct answer. For example, as for the requirement information whose requirement ID is 1, a requirement such that the attribution contribution of “male” and “female” is less than 20 is defined. For example, as for the requirement information whose requirement ID is 2, a requirement such that the age is over 60 and the attribution contribution is less than 20 is defined. In the table illustrated in FIG. 15, Null indicates that no condition is set for a column.

The display unit 104 displays the level of deviation of the correct answer from the initial value and the level of discrimination based on the contribution for the editing frequency at which the level of satisfying the requirement information exceeds a predetermined threshold. The level of satisfying the requirement information means, for example, a level of satisfying how many requirements among a designated plurality of requirements. The level may be a frequency or a rate of satisfying requirements.

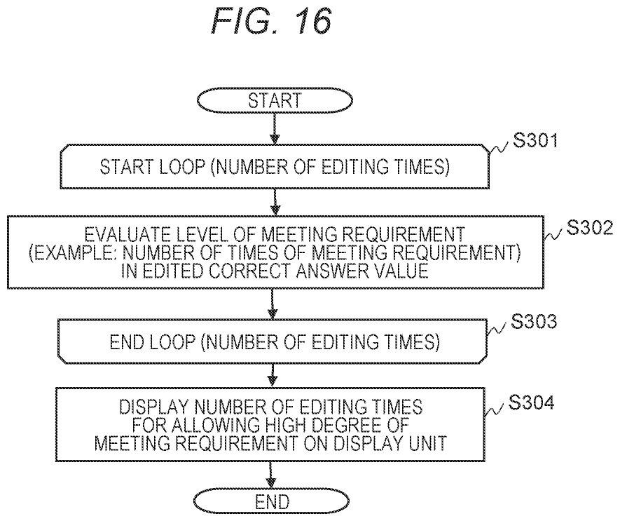

FIG. 16 is a flowchart illustrating information processing performed by the suggestion generating unit. The suggestion generating unit 109 performs processing in step S302 at each editing (loop in steps S301 and S303). In step S302, the suggestion generating unit 109 evaluates the level of satisfying the requirement information for the edited correct answer value. The evaluation herein may mean calculation or computation. The suggestion generating unit 109 displays information about the editing frequency at which the level of satisfying the requirements is high on the display unit 104 (step S304).

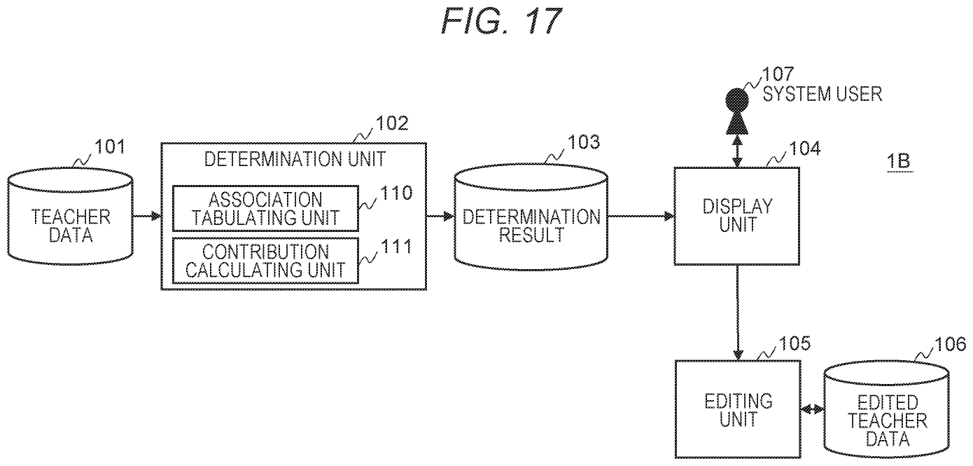

FIG. 17 is a functional block diagram illustrating a configuration example of the teacher data editing support system. Since the configuration of a teacher data editing support system 1B illustrated in FIG. 17 is approximately similar to the configuration of the teacher data editing support system 1 illustrated in FIG. 1, only the difference will be described.

The teacher data editing support system 1B includes a processing device. As described above, the processing device reads various programs and data stored in the storage device and executes the programs, thereby implementing the determination unit 102, the display unit 104, and the editing unit 105. Here, the determination unit 102 includes an association tabulating unit 110 and a contribution calculating unit 111.

The association tabulating unit 110 sets, as associations, all subsets in a set including the sensitive attribution and the feature as elements, and designates, among all pieces of teacher data, some pieces of teacher data in which the elements included in the associations are similar, as similar data. The contribution calculating unit 111 calculates an average value of correct answers in all the associations in each pieces of the teacher data as the similar data among all pieces of the teacher data, calculates, as provisional contribution, a difference between the average values of the correct answers for combinations of two associations in which only the presence or absence of the sensitive attribution is a difference for respective sensitive attribution, and calculates an average value of the provisional contribution as the sensitive attribution contribution.

Note that a similarity determination criterion in the association tabulating unit 110 may be based on a threshold, matching, or the like. For example, in a case where an element included in the association in certain teacher data is a continuous value A, a similar range can be defined as a threshold. For example, a case where values from the continuous value A −100 to the continuous value A +100 may be determined as similar, and other cases may be determined as dissimilar. In a case where an element included in the association in certain teacher data is a category value, a determination may be made as similar when the category matching is made. The similarity determination criteria are not limited to those described above.

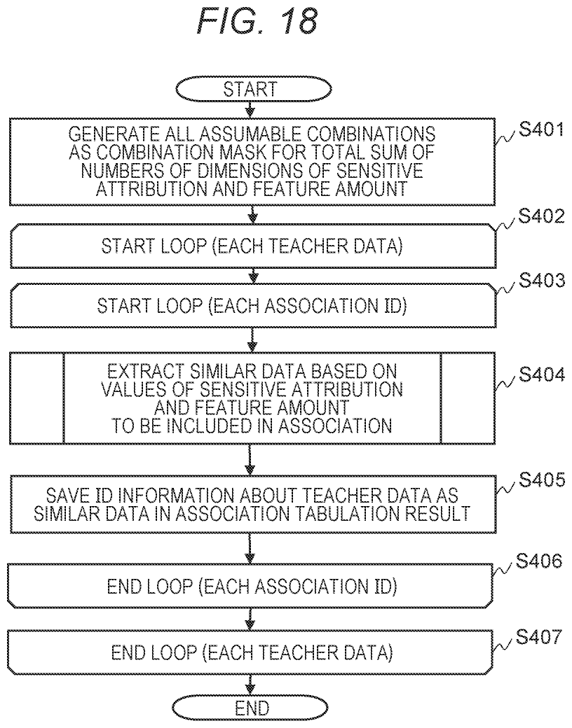

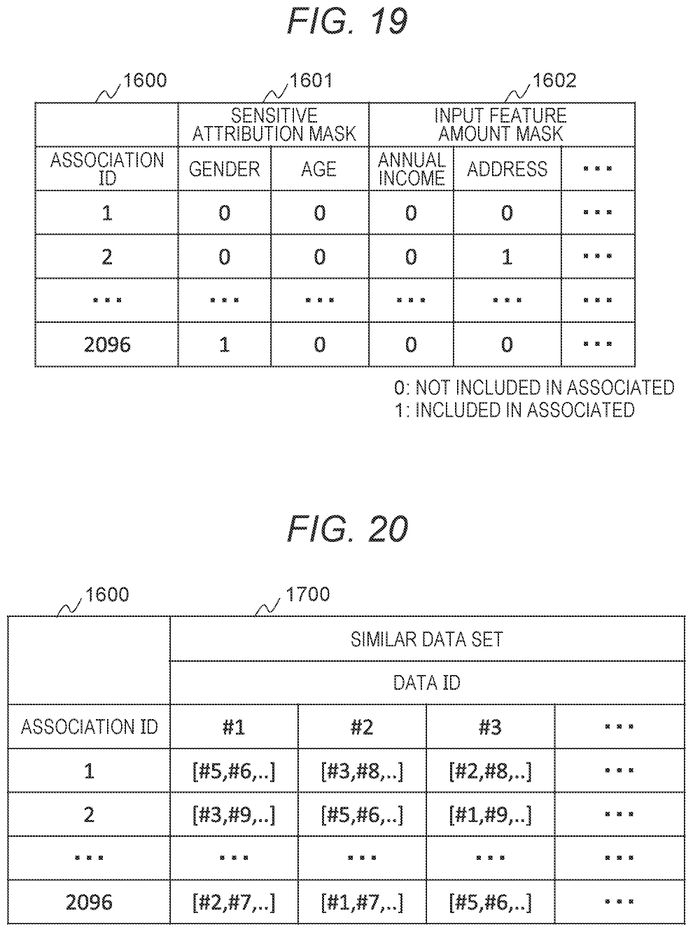

FIG. 18 is a flowchart illustrating information processing performed by the association tabulating unit. The association tabulating unit 110 generates all assumable combinations as combination masks for the sum of the number of dimensions of the sensitive attribution and the feature (S401). Note that the combination masks will be described later with reference to FIG. 19.

The association tabulating unit 110 performs the processing in steps S403 to S406 for each teacher data (loop in steps S402 and S407). The association tabulating unit 110 performs the processing in steps S404 and S405 for each association ID (loop in steps S403 and S406).

In step S404, the association tabulating unit 110 extracts similar data based on the values of the sensitive attribution and feature included in the associations (S404). Note that a threshold for determining for the similar state may be determined in advance based on the distribution of values in the sensitive attribution and the feature taking the continuous values in the entire teacher data.

In step S405, the association tabulating unit 110 stores the ID information about the teacher data which is the similar data, as an association tabulating result. Note that the association tabulating result will be described below with reference to FIG. 20.

FIG. 19 is a conceptual diagram illustrating a format of the combination mask. The combination mask includes an association ID 1600, a sensitive attribution mask 1601, and an input feature mask 1602 as information items (columns). The association ID is identification information that uniquely identifies an association. The sensitive attribution mask 1601 includes items indicating sensitive attribution such as gender and age. The input feature mask includes items indicating input features such as annual income and address. A value of 0 or 1 is set to the combination mask. The value of 0 means that the item is not included in the association. A value of 1 means that an item is included in the association. For example, the association whose association ID is 2 includes the item of an address in the input feature mask 1602. In step S401, the association tabulating unit 110 generates all assumable patterns of combinations in which the value of each column is 0 or 1.

FIG. 20 is a conceptual diagram illustrating a format of an association tabulating result. The association tabulating result is data that is saved as a history indicating as for each piece of teacher data, which data is extracted as similar data in each association pattern.

The association tabulating result includes the association ID 1600 and a similar data set 1700 as information items (columns). Since the association ID 1600 is similar to that described with reference to FIG. 19, detailed description thereof will be omitted. The similar data set 1700 includes a plurality of types of data indicating which data is extracted as similar data in each association pattern for each piece of teacher data. For example, as for data whose association ID is 1 and data ID is 1, data #5, #6, and.. . . . . are extracted as similar data. As for data whose association ID is 1 and data ID is 2, data #3, #8, and.. . . . . are extracted as data similar.

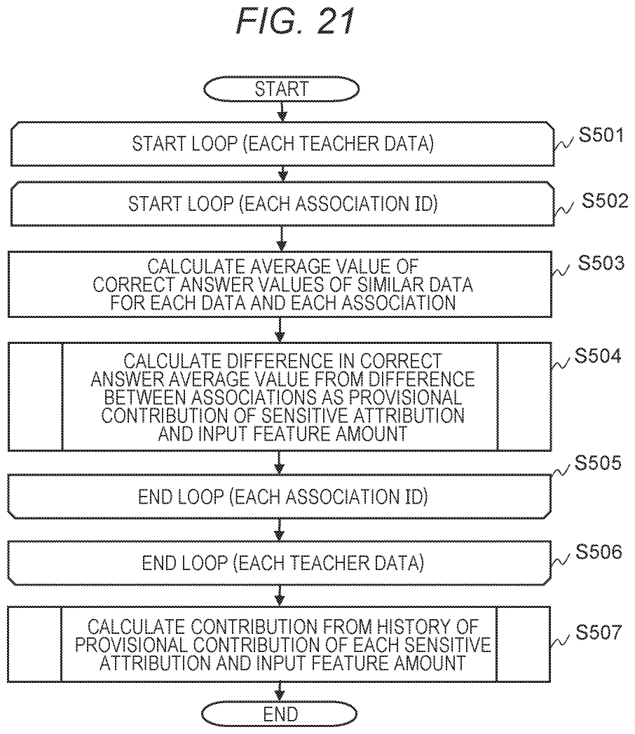

FIG. 21 is a flowchart illustrating information processing performed by the contribution calculating unit.

The contribution calculating unit 111 executes the processing in steps S502 to S505 for each teacher data (loop in steps S501 and S506). The contribution calculating unit 111 executes the processing in steps S503 and S504 for each association ID (loop in steps S502 and S505).

In step S503, the contribution calculating unit 111 calculates an average value of the correct answer values in similar data for each data and each association. In step S504, the contribution calculating unit 111 calculates a difference between the correct answer average values based on the differences between the associations as provisional contribution of the sensitive attribution and the input feature.

In step S507, the contribution calculating unit 111 calculates the contribution based on the history of the provisional contribution of each sensitive attribution and input feature. For example, the contribution of the sensitive attribution and the input feature is calculated by calculating an average value for all combination patterns of the association IDs.

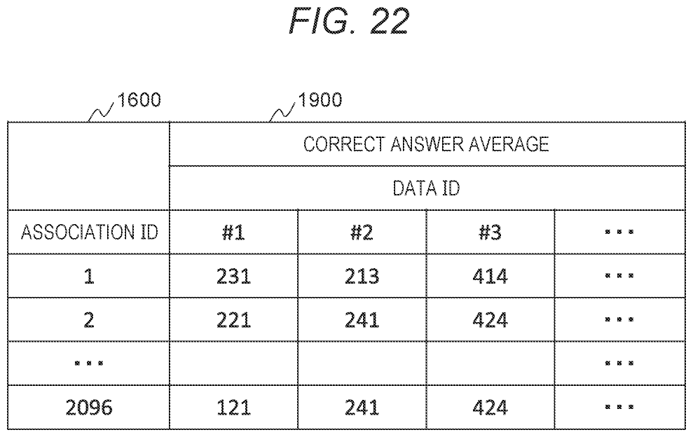

FIG. 22 is a conceptual diagram illustrating a format of an association tabulating result. The format of the association tabulating result is similar to the format of the association tabulating result described with reference to FIG. 20. In the case of FIG. 20, similar data is extracted for each association ID and data ID. For example, similar data whose association ID is 1 and data ID is 1 is data #5, #6, and . . . . . . (see FIG. 20). In step S503, the contribution calculating unit 111 calculates an average value among the correct answer values of the data #5, #6, and . . . . . For example, the average value of the correct answer values is 231 for the similar data whose data ID is 1 and association ID is 1. When the average value calculation is performed for each association ID and data ID, correct answer average value results are calculated as illustrated in FIG. 22.

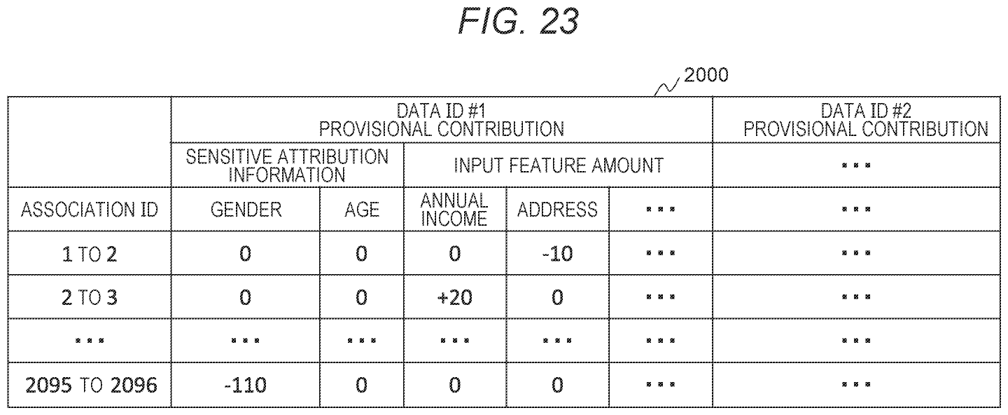

FIG. 23 is a conceptual diagram illustrating a format of a provisional contribution result. As described above, in step S504, the contribution calculating unit 111 calculates a difference between the correct answer average values based on the differences between the associations as the provisional contribution of the sensitive attribution and the input feature. FIG. 23 illustrates calculated provisional contribution 2000.

In step S504, the contribution calculating unit 111 calculates a difference between, for example, first data whose association ID is 1 and second data whose association ID is 2 and data ID is 1. In the illustrated example, since there is no difference between the first data and the second data regarding gender, age, annual income, and the like, a difference value is 0. Regarding the address, since there is a difference between the first data and the second data, the difference value is −10. That is, a difference between the correct answer average value of 231 in the first data and a correct answer average value of 221 in the second data is obtained. A value of −10 obtained by subtracting the correct answer average value of 231 in the first data from the correct answer average value of 221 in the second data indicates provisional contribution made by causing “address” to be included in the association.

The contribution calculating unit 111 similarly calculates a difference between the second data whose association ID is 2 and data ID is 1 and third data whose association ID is 3 and data ID is 1. In this case, since there is no difference between the second data and the third data regarding gender, age, and address, the difference value is 0. Regarding the annual income, since there is a difference between the second data and the third data, the difference value is +20.

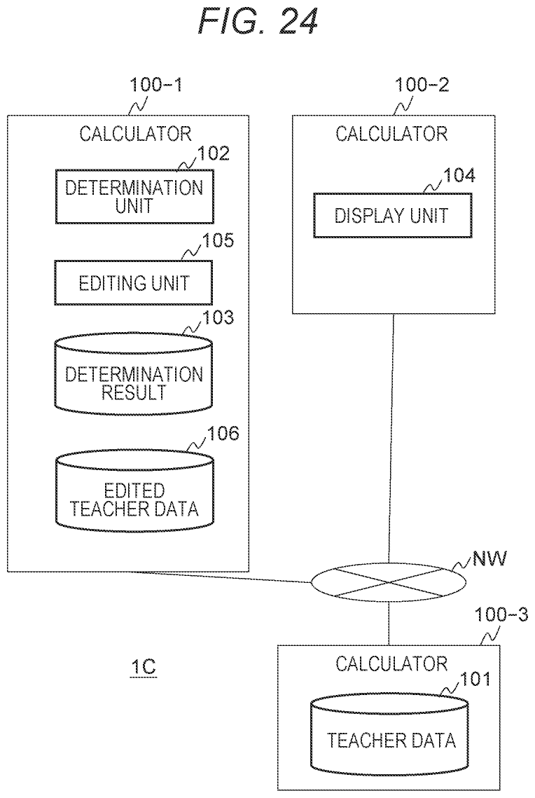

FIG. 24 is a block diagram illustrating a configuration example of the teacher data editing support system. The functional units and data constituting the teacher data editing support system 1 may be converged into one device, or may be distributively disposed in a plurality of devices. FIG. 24 illustrates an example of a distributive disposition.

A teacher data editing support system 1C illustrated in FIG. 24 includes a calculator 100-1, a calculator 100-2, and a calculator 100-3. These calculators are communicably connected to each other via a communication line NW such as the Internet.

The calculator 100-1 in the teacher data editing support system 1C corresponds to a server. The calculator 100-2 corresponds to a user terminal. The calculator 100-3 corresponds to a data server. The calculators 100-1, 100-2, and 100-3 each have a processing device and a storage device.

The processing device of the calculator 100-1 reads various programs and data stored in the storage device and executes the programs, thereby implementing the determination unit 102 and the editing unit 105. The determination result 103 and the edited teacher data 106 are stored in the storage device of the calculator 100-1. The processing device of the calculator 100-2 reads various programs and data stored in the storage device and executes the programs, thereby implementing the display unit 104. The teacher data 101 is stored in the storage device of the calculator 100-3.

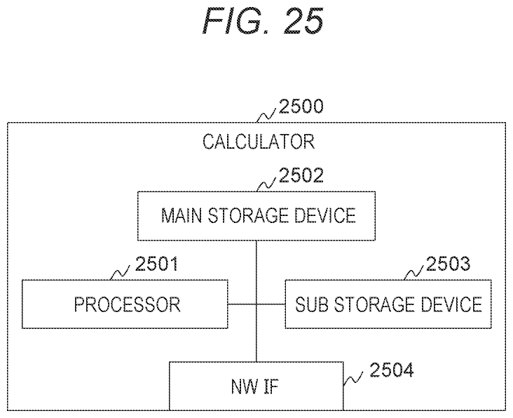

FIG. 25 is a conceptual diagram illustrating a hardware configuration example of the calculator. A calculator 2500 corresponds to each of the calculators 100-1, 100-2, and 100-3 illustrated in FIG. 24. The calculator 2500 includes a processor 2501, a main storage device 2502, a sub storage device 2503, and a network interface 2504. The processor 2501 corresponds to the above-described processing device. The main storage device 2502 and the sub storage device 2503 correspond to the above-described storage device. The network interface 2504 is a device for communication with an external device or the like via the network NW illustrated in FIG. 24.

The above-described embodiments of the present invention are examples for describing the present invention, and the scope of the present invention is not intended to be limited only to the embodiments. A person skilled in the art can carry out the present invention in various other aspects without departing from the scope of the present invention.

As described above, a teacher data editing support system includes a determination unit that receives teacher data including sensitive attribution as a variable that potentially causes discrimination, a feature as a variable to be used for prediction, and a correct answer, and calculates contribution as an index indicating contribution of the sensitive attribution to the correct answer, a display unit that visually presents evaluation information indicating a relationship between a level of changing the correct answer in the teacher data and a level of deviation of the correct answer from an initial value or a discrimination level based on the contribution, and an editing unit that accepts designation of how much the correct answer is changed, changes the correct answer in the teacher data in response to the designation, and outputs the changed teacher data.

A teacher data editing support method performed by an apparatus having a processing device, includes receiving teacher data including sensitive attribution as a variable that potentially causes discrimination, a feature as a variable to be used for prediction, and a correct answer and calculating contribution as an index indicating contribution of the sensitive attribution to the correct answer, visually presenting evaluation information indicating a relationship between a level of changing the correct answer in the teacher data and a level of deviation of the correct answer from an initial value or a discrimination level based on the contribution, and accepting designation of how much the correct answer is changed, changing the correct answer in the teacher data in response to the designation, and outputting the changed teacher data.

A teacher data editing support program for causing an apparatus having a processing device to implement a determination function that receives teacher data including sensitive attribution as a variable that potentially causes discrimination, a feature as a variable to be used for prediction, and a correct answer and calculates contribution as an index indicating contribution of the sensitive attribution to the correct answer, a display function that visually presents evaluation information indicating a relationship between a level of changing the correct answer in the teacher data and a level of deviation of the correct answer from an initial value or a discrimination level based on the contribution, and an editing function that accepts designation of how much the correct answer is changed, changes the correct answer in the teacher data in response to the designation, and outputs the changed teacher data.

According to the above description, it is possible to support a reduction in a sensitive determination made by a machine learning model.

The contribution is a numerical value indicating a portion caused by the sensitive attribution in the numerical values indicating the correct answers. The determination unit repeatedly editing for subtracting the numerical value of the contribution from the numerical value indicating the correct answer and perform calculating the level of deviation of the correct answer from the initial value and the level of discrimination based on the contribution. The display unit displays the level of the deviation of the correct answer from the initial value with respect to an editing frequency and the level of discrimination based on the contribution. As a result, the level of the deviation of the correct answer from the initial value and the level of discrimination based on the contribution can be visualized depending on the editing frequency and can be provided to the user.

The display unit displays a graph indicating the level of the deviation of the correct answer from the initial value with respect to the editing frequency and the level of discrimination based on the contribution. As a result, the level of the deviation of the correct answer from the initial value and the level of the discrimination based on the contribution can be visualized depending on the editing frequency and can be provided to the user.

The teacher data is teacher data used for machine learning of a problem of identification for classifying data into a plurality of categories. As for the initial value of the correct answer, a value in any one of the plurality of categories is 1, and values of the other categories are 0. The determination unit calculates the contribution of the sensitive attribution for each category in one editing, and subtracts the contribution of the sensitive attribution in that category from the value of the category in the correct answer. As a result, even in the case of using the teacher data of the identification problem, it is possible to support a reduction in the sensitive determination made by the machine learning model.

The system further includes a suggestion generating unit that accepts designation of requirement information to be satisfied by the contribution of the sensitive attribution, and calculates how much the contribution satisfies the requirement information every time of the editing. The display unit displays the level of the deviation of the correct answer from the initial value with respect to the editing frequency and the level of discrimination based on the contribution for the editing frequency at which the level of satisfying the requirement information exceeds a predetermined threshold. As a result, in response to the designation of the requirement information, the editing frequency at which the level of satisfying the requirement information is high can be visualized and presented to the user.

The contribution is a Shapley value with respect to the sensitive attribution in the correct answer, and this can support a reduction in the sensitive determination made by the machine learning model based on the Shapley value.

The determination unit includes an association tabulating unit that sets, as associations, all subsets in a set including the sensitive attribution and the feature as elements, and designates, among all pieces of the teacher data, some pieces of the teacher data in which the elements included in the associations are similar, as similar teacher data, and a contribution calculating unit that calculates an average value of correct answer of the similar teacher data for all the associations among all pieces of the teacher data, calculates, as provisional contribution for each sensitive attribution, a difference in the average value of the correct answer for each combination of two associations in which only presence or absence of the sensitive attribution is different, and calculates an average value of the provisional contribution as the contribution of the sensitive attribution. Therefore, the contribution in consideration of the association can be calculated.

What is claimed is:

1. A teacher data editing support system, comprising:
a determination unit that receives teacher data including sensitive attribution as a variable that potentially causes discrimination, a feature as a variable to be used for prediction, and a correct answer, and calculates contribution as an index indicating contribution of the sensitive attribution to the correct answer;
a display unit that visually presents evaluation information indicating a relationship between a level of changing the correct answer in the teacher data and a level of deviation of the correct answer from an initial value or a discrimination level based on the contribution; and
an editing unit that accepts designation of how much the correct answer is changed, changes the correct answer in the teacher data in response to the designation, and outputs the changed teacher data.

2. The teacher data editing support system according to claim 1, wherein
the contribution is a numerical value indicating a portion caused by the sensitive attribution in the numerical value indicating the correct answer,
the determination unit repeatedly perform editing for subtracting the numerical value of the contribution from the numerical value indicating the correct answer, and perform calculating the level of deviation of the correct answer from the initial value and the level of discrimination based on the contribution, and
the display unit displays the level of the deviation of the correct answer from the initial value with respect to an editing frequency and the level of the discrimination based on the contribution.

3. The teacher data editing support system according to claim 2, wherein the display unit displays a graph indicating the level of the deviation of the correct answer from the initial value with respect to the editing frequency and the level of the discrimination based on the contribution with respect to the editing frequency.

4. The teacher data editing support system according to claim 2, wherein
the teacher data is teacher data used for machine learning of a problem of identification for classifying data into a plurality of categories, and as for the initial value of the correct answer, a value in any one of the plurality of category is 1, and values of the other categories are 0, and
the determination unit calculates the contribution of the sensitive attribution for each of the plurality of categories in one editing, and subtracts the contribution of the sensitive attribution in the category from the value of the category in the correct answer.

5. The teacher data editing support system according to claim 2, further comprising a suggestion generating unit that accepts designation of requirement information to be satisfied by the contribution of the sensitive attribution, and calculates how much the contribution satisfies the requirement information every time of the editing, wherein
the display unit displays the level of the deviation of the correct answer from the initial value with respect to the editing frequency and the level of the discrimination based on the contribution for the editing frequency at which the level of satisfying the requirement information exceeds a predetermined threshold.

6. The teacher data editing support system according to claim 2, wherein the contribution is a Shapley value with respect to the sensitive attribution in the correct answer.

7. The teacher data editing support system according to claim 6, wherein the determination unit includes
an association tabulating unit that sets, as associations, all subsets in a set including the sensitive attribution and the feature as elements, and designates, among all pieces of the teacher data, some pieces of the teacher data in which the elements included in the associations are similar, as similar teacher data, and
a contribution calculating unit that calculates an average value of correct answer of the similar teacher data for all the associations among all pieces of the teacher data, calculates, as provisional contribution for each sensitive attribution, a difference in the average value of the correct answer for each combination of two associations in which only presence or absence of the sensitive attribution is different, and calculates an average value of the provisional contribution as the contribution of the sensitive attribution.

8. A teacher data editing support method performed by an apparatus having a processing device, the method comprising:
receiving teacher data including sensitive attribution as a variable that potentially causes discrimination, a feature as a variable to be used for prediction, and a correct answer and calculating contribution as an index indicating contribution of the sensitive attribution to the correct answer;
visually presenting evaluation information indicating a relationship between a level of changing the correct answer in the teacher data and a level of deviation of the correct answer from an initial value or a discrimination level based on the contribution; and
accepting designation of how much the correct answer is changed, changing the correct answer in the teacher data in response to the designation, and outputting the changed teacher data.

9. A teacher data editing support program for causing an apparatus having a processing device to perform:
receiving teacher data including sensitive attribution as a variable that potentially causes discrimination, a feature as a variable to be used for prediction, and a correct answer and calculating contribution as an index indicating contribution of the sensitive attribution to the correct answer;
visually presenting evaluation information indicating a relationship between a level of changing the correct answer in the teacher data and a level of deviation of the correct answer from an initial value or a discrimination level based on the contribution; and
accepting designation of how much the correct answer is changed, changing the correct answer in the teacher data in response to the designation, and outputting the changed teacher data.
